(19) United States
(12) Patent Application Publication
(10) Pub. No.: US 2025/0098877 A1
(43) Pub. Date: Mar. 27, 2025

(54) Wall-Mounted Modular Multipurpose Wall Hanging System

(71) Applicant: Marvin Harvey, Indianapolis, IN (US)

(72) Inventor: Marvin Harvey, Indianapolis, IN (US)

(21) Appl. No.: 18/428,048

(22) Filed: Jan. 31, 2024

Related U.S. Application Data
(60) Provisional application No. 63/584,960, filed on Sep. 25, 2023.

(51) Int. Cl. A47G 1/20; F16B 25/00

(52) U.S. Cl. CPC A47G 1/20; F16B 25/0026

(57) ABSTRACT

The present invention relates to an interchangeable wall hanging system for efficiently and aesthetically hang different objects such as picture frames, decorative pieces, and more. The system features a base with a circumferential protruding wall, equipped with continuous threads for engagement with interchangeable tops/hangers/mounts. A stud screw with a threaded longitudinal section secures the base to a wall, while the head and washer of the stud screw remain concealed by the top/hanger/mount. The interchangeable tops/hangers/mounts are designed for easy attachment and detachment through a twisting motion. Each top/hanger/mount features internal threads for secure engagement with the base and are equipped with different hooks, including an elongated straight hook and a circular loop.

### CROSS-REFERENCE TO RELATED APPLICATION

The present application claims priority to, and the benefit of, U.S. Provisional Application No. 63/584,960, which was filed on Sep. 25, 2023 and is incorporated herein by reference in its entirety.

### FIELD OF THE INVENTION

The present invention generally relates to the field of wall-mounted screws or wall anchors. More specifically, the present invention relates to a novel wall hanging system with interchangeable heads, top/hanger/mounts, or hangers for hanging different types of items/objects. The system allows users to choose a different top/hanger/mount and securely attach the top/hanger/mount to the screw base that is inserted into a wall surface. The top/hanger/mount/head can be twisted on or twisted off to engage and disengage the screw base and the head. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals commonly hang different items, such as picture frames, decorative pieces, and the like, on walls to enhance the aesthetic appeal of their living spaces. To securely attach such objects to the wall surface, different types of screws, wall anchors, or fasteners are employed. The specific type of fastener chosen depends on the weight of the object, the material of the wall, and the desired level of security. Different wall materials offer varying levels of support. For drywall, screws or wall anchors with self-tapping threads can be suitable and for concrete or brick walls, masonry screws or anchors are used. Using the wrong type of screw or fastener can lead to damage to the wall or the item falling off.

It is common for individuals to remove a hung object after some time or when the object is broken and when the object is removed, a screw hole is left behind. Even the conventional screws or wall anchors along with the holes can be unsightly and may require filling, patching, and painting to restore the wall's appearance. Painting and filling are expensive and time consuming. In rental properties such modifications can lead to deductions from security deposits.

Reusing screws or wall anchors for hanging different items is not always feasible. Different items may require screws or wall anchors of different lengths and gauges, or with different load-bearing capacities. Moreover, repeatedly using the same screw can wear the screw out, making the screw less secure and potentially unsafe for hanging objects. The type of fastener and its visibility can also affect the overall look of the hung object. Individuals prefer hidden fasteners for a cleaner look, which might not be possible with certain types of objects or fasteners. Individuals also desire an improved fastener device that can be used for different types of objects while maintaining aesthetics.

Therefore, there exists a long felt need in the art for an improved wall hanging system that has interchangeable heads or tops/hangers/mounts to hang different objects. Additionally, there is a long felt need in the art for an aesthetic wall hanging system that can be adapted to hang various types of items, such as picture frames, decorative pieces, etc. Moreover, there is a long felt need in the art for an improved wall hanging system that eliminates the need for multiple types of screws or wall anchors for hanging different items. Further, there is a long felt need in the art for a wall hanging system that includes a base and a plurality of different tops/hangers/mounts, the top/hanger/mount part can be swapped as needed to hang different objects. Furthermore, there is a long felt need in the art for a wall hanging system that enables users to move and hang different items around without having to reapply new screws or wall anchors to the wall each time. Also, there is a long felt need in the art for a multifunctional wall hanging system that saves time and effort and reduces wall damage caused by repeatedly drilling new holes. Finally, there is a long felt need in the art for a multifunctional wall hanging system that has interchangeable heads or tops/hangers/mounts and simplifies the process of decorating and redecorating spaces, reduces the need for multiple types of hanging hardware, and minimizes wall damage.

The subject matter disclosed and claimed herein, in one embodiment thereof, comprises a modular wall-mounting multifunctional wall hanging system for hanging objects. The wall hanging system includes a circular base designed for attachment to a mounting wall and features a bottom surface and a circumferential protruding wall or sleeve. A set of continuous threads (i.e., female threads) are disposed on the outer surface of the circumferential protruding wall. The continuous threads are distal to the mounted wall. A stud screw extends through the center of the bottom surface and is secured with a washer. The threaded portion of the stud screw is drilled, turned, or otherwise installed in the mounting wall. An interchangeable top, hanger, or head with a base and a protruding circumferential wall or sleeve is included to be removably fastened to the base. A hook is located on the outer surface of a concave base of the head for hanging objects. A set of threads (i.e., female threads) are disposed on the inner surface of the protruding circumferential wall of the head, which engage with the continuous threads of the base upon twisting, enabling attachment and detachment of the head to and from the base. The hook can be a conventional hook, straight hook, circular hook, and more.

In this manner, the modular wall-mounting multifunctional wall hanging system of the present invention accomplishes all of the forgoing objectives and provides users with a wall-mounted wall hanging system for hanging a wide range of items, from picture frames to decorative pieces, and more. The interchangeable tops/hangers/mounts make the system adaptable to various weights and sizes of objects, providing flexibility in home or office decoration. Use of the same base with different tops/hangers/mounts obviates the need to drill new holes in the wall for different items. The wall hanging system is easy to use and preserves the integrity of wall surfaces.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multifunctional wall hanging system for hanging objects. The wall hanging system further comprising a screw base designed for attachment to a mounting wall and features a bottom surface and a circumferential protruding wall or sleeve. A set of continuous threads (i.e., female threads) are disposed on the outer surface of the circumferential protruding sleeve. A stud screw extends through the center of the bottom surface and is secured with a washer. An interchangeable top, hanger, or head with a circular concave base and a protruding circumferential wall is included to be removably fastened to the screw base. A hook or hanger is located on the outer surface of the concave base of the head for hanging objects. A set of threads (i.e., male threads) are disposed on the inner surface of the protruding circumferential wall or sleeve of the head, which engage with the continuous female threads of the base upon twisting, enabling attachment and detachment of the head to and from the base.

In yet another embodiment, a wall hanging system for hanging and repositioning items is disclosed. The wall hanging system further comprising a wall-mountable circular base with a bottom surface having a centered stud screw passing therethrough, where the stud screw is fixed with a washer on one side and extends a threaded section into the mounting wall for retention. The circular base includes a circumferential protruding wall or sleeve with a set of external threads (i.e., male threads) starting from a free edge thereof. An interchangeable top/hanger/mount component features a concave base with a central hook for item suspension and a circumferential wall with internal threads (i.e., female threads). The internal threads of the top/hanger/mount component's circumferential wall are designed to engage with the external threads of the base's protruding wall, enabling a detachable connection for the purpose of changing or repositioning hung items without the need for additional screws or wall anchors.

In a further embodiment of the present invention, a multifunctional wall hanging system is disclosed. The system includes a base and a head that, when assembled in a deployed position, engage through threads on a protruding wall of the head with threads on a circumferential protruding wall of the base. The design of the base and head conceals the stud screw and washer when in the deployed position, thereby enhancing the aesthetic appeal of the wall hanging system. The base and head, along with a hook on the head, are constructed from, for example, steel with a powder coating, available in various colors and designs. The powder coating is resistant to chipping, scratching, and fading. Other materials, such as plastics and polymers, are suitable for constructing the base and head.

In another aspect, the inner surface of the protruding circumferential wall of the head contacts the outer surface of the circumferential protruding wall of the base when the head is twisted onto the base for installation, providing a secure and stable positioning of the multifunctional wall hanging system.

In yet another embodiment, an elongated straight hook is disposed on the outer surface of the head and is structured to support and hang a plurality of objects. The elongated hook further comprising a plurality of protrusions, strategically positioned to provide additional support and stability to the hanging objects, optimizing the distribution of weight and enhancing the overall utility of the wall hanging system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the multifunctional wall hanging system of the present invention in an uninstalled position in accordance with the disclosed structure;

FIG. 2 illustrates a perspective view of the wall hanging system of FIG. 1 in a deployed position in accordance with the disclosed structure;

FIG. 3 illustrates a side perspective view showing the multifunctional wall hanging system of FIG. 1 deployed in a wall in accordance with one embodiment of the present invention;

FIG. 4 illustrates a perspective view of another embodiment of the interchangeable head used in the multifunctional wall hanging system of the present invention in accordance with the disclosed structure; and

FIG. 5 illustrates yet another embodiment of the multipurpose wall hanging system of the present invention with a circle hook in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved wall hanging system that has interchangeable heads, tops, or hangers to hang different objects. Additionally, there is a long felt need in the art for an aesthetic wall hanging system that can be adapted to hang various types of items, such as picture frames, decorative pieces, etc. Moreover, there is a long felt need in the art for an improved wall screw or hanging system that obviates the need for multiple types of screws or wall anchors for different items. Further, there is a long felt need in the art for a wall hanging system that includes a base and a plurality of different interchangeable tops/hangers/mounts, the top/hanger/mount part can be swapped or interchanged as needed to hang different objects. Furthermore, there is a long felt need in the art for a wall hanging system that enables users to move and hang different items on a wall without having to reapply new screws or wall anchors to the wall each time. Also, there is a long felt need in the art for a multifunctional wall hanging system that saves time and effort and reduces wall damage caused by repeatedly drilling new holes. Finally, there is a long felt need in the art for a multifunctional wall hanging system that has interchangeable heads, tops, hangers, or mounts and simplifies the process of decorating and redecorating spaces, reduces the need for multiple types of hanging hardware, and minimizes wall damage.

The present invention, in one exemplary embodiment, is a multifunctional wall hanging system. The system is adapted to be in an uninstalled and a deployed position. The system includes a base and a head that, when assembled in a deployed position, engage through threads on a protruding wall of the head with threads on a circumferential protruding wall of the base. The design of the base and head conceals the stud screw and washer when in the deployed position, thereby enhancing the aesthetic appeal of the wall hanging system. The base and head, along with a hook on the head, are constructed from, for example, steel with a powder coating, available in various colors and designs. The powder coating is resistant to chipping, scratching, and fading. The head can be twisted off to disengage the threads to remove the head from the base, wherein the head can be interchanged with any other head. Other materials, such as plastics and polymers, are suitable for constructing the base and head.

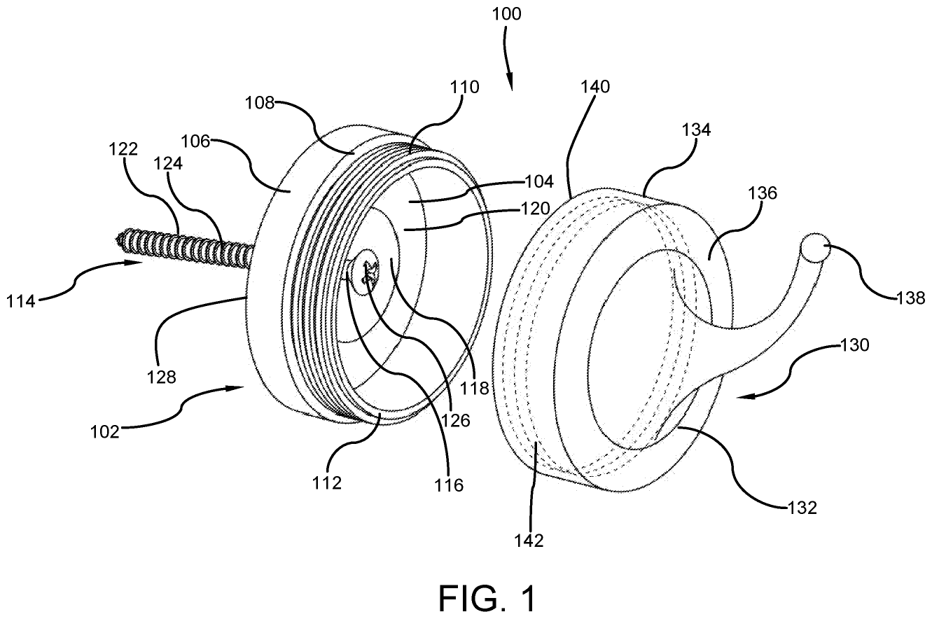

Referring initially to the drawings, FIG. 1 illustrates a perspective view of one potential embodiment of the multifunctional wall hanging system of the present invention in an uninstalled position in accordance with the disclosed structure. The multifunctional wall hanging system 100 is an improved wall hanging system that can be adapted to hang various types of items, such as picture frames, decorative pieces, and more. The wall hanging system 100 provides users the ability to move and hang different items on a wall without having to reapply new screws or wall anchors to the wall each time. More specifically, the multifunctional wall-mounted wall hanging system 100 includes a circular screw base 102 adapted to be fixed to a wall. The circular base 102 includes a bottom surface 104 and a circumferential protruding wall or sleeve 106. The outer surface 108 of the circumferential protruding wall or sleeve 106 includes a set of continuous threads 110 with the threads 110 originating from the free edge 112 of the circumferential protruding wall or sleeve 106.

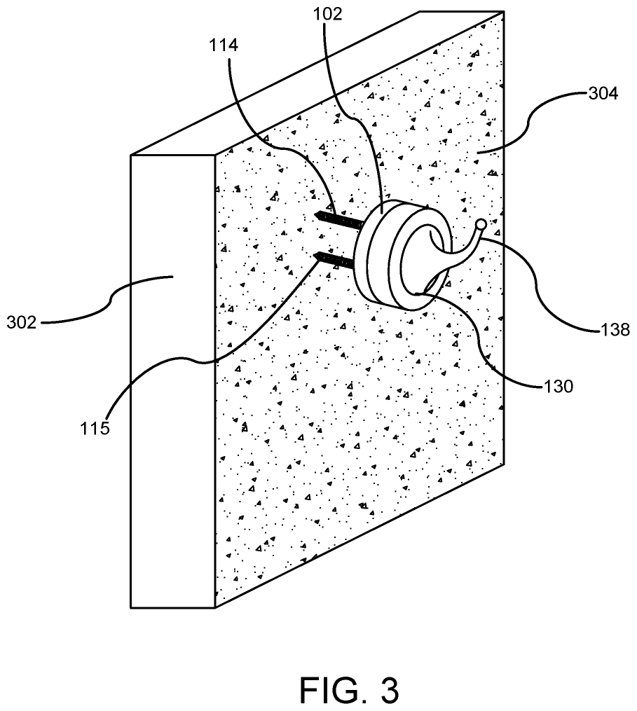

A stud screw(s) 114 passes through the center 116 of the bottom surface 104 and is secured using a washer 118 on the first side 120 of the bottom surface 104. The longitudinal section 122 of the stud screw(s) 114 has a plurality of threads 124 and can be used for fixing the base 102 in a wall. The head 126 of the stud screw 114 rests on the first side 120 and the base 102 can be drilled or turned into a wall such that the second side 128 of the screw base 102 rests on the surface of the wall as illustrated in FIG. 3. It is to be appreciated that more than one screw 114 can be used for mounting the base 102 to the mounting wall. FIG. 3 illustrates two mounting screws 114, 115 for mounting the base 102 to the mounting wall.

The modular wall-mounting wall hanging system 100 includes an interchangeable top, hanger, mount, or head 130 that is adapted to be selectively and removably fastened to the base 102. The head 130 includes a circular concave shaped base 132 and a protruding circumferential wall 134. The outer surface 136 of the base 132 includes a hook 138 for hanging one or more items. The inner surface 140 of the protruding circumferential wall 134 includes a set of threads (i.e., female threads) 142 that upon twisting the head 130 along the circumferential protruding wall or sleeve 106 engages/fastens with the continuous threads (i.e., male threads) 110 of the screw base 102. The head 130 is attached/twisted on to the base 102 when the threads 142 engages with the continuous threads 110 of the base 102. The head 130 can be detached/twisted off by twisting the head 130 in an opposite direction (i.e., counterclockwise) to disengage the threads 142 and the threads 110.

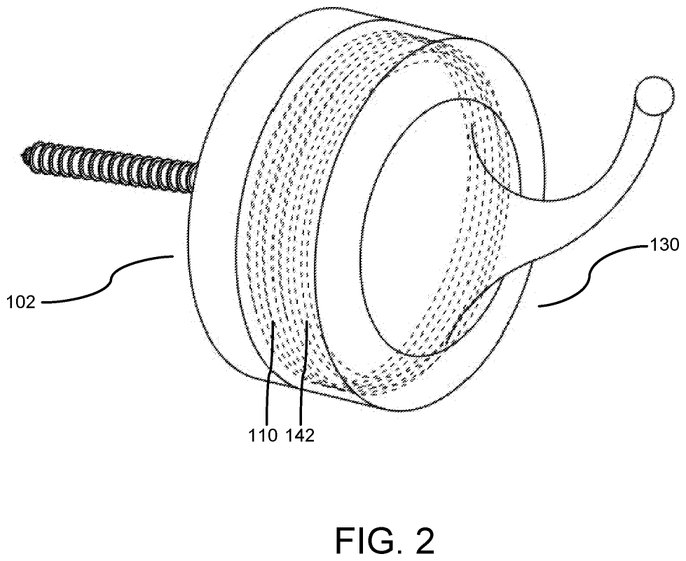

Referring now to FIG. 2, the multifunctional wall hanging system of FIG. 1 is displayed in an installed or deployed position. In the deployed position, the threads 142 of the head 102 are engaged with the threads 110 of the circumferential protruding wall or sleeve 106. The stud 114 and the washer 118 are not visible and the wall hanging system 100 is aesthetically pleasing. Further, the base 102 and the head 130 along with the hook 138 are preferably made from steel with powder coating and come in different colors, designs, and designs. Powder coating is resistant to chipping, scratching, and fading allowing the modular wall-mounting wall hanging system 100 to retain the attractive appearance even with regular use and handling. In other embodiments, the base 102, head 130, and hook 138 can be formed from rigid plastics or polymers.

The base 102 and the head 130 are designed such that the inner surface 140 of protruding circumferential wall 134 of the head 130 touches the outer surface 108 of the circumferential protruding wall or sleeve 106 when the head 130 is twisted on to install or deploy the multifunctional wall hanging system 100 for a secure and stable position of the multifunctional wall hanging system.

FIG. 3 illustrates a side perspective view showing the multifunctional wall hanging system of FIG. 1 deployed in a wall in accordance with one embodiment of the present invention. The stud screw 114 is drilled or turned into the wall 302 using any conventional drill and the base 102 abuts against the wall surface 304. The interchangeable head 130 is twisted on as described earlier in the disclosure and the hook 138 is used for hanging an object. The object can also be replaced easily with any other object without removing/displacing the base 102.

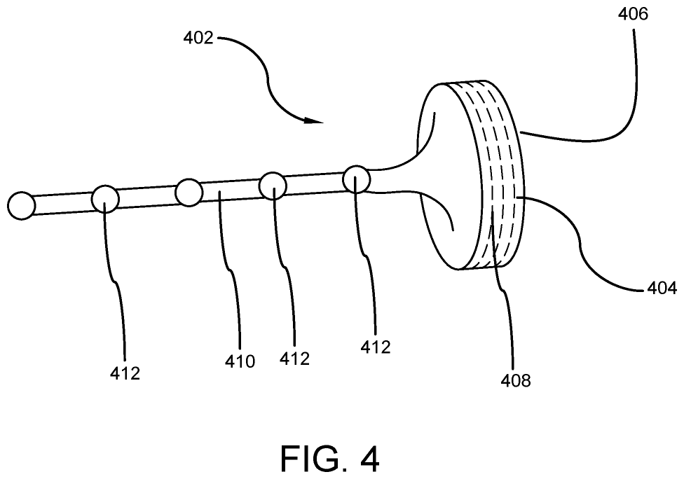

FIG. 4 illustrates a perspective view of another embodiment of the interchangeable head used in the multifunctional wall hanging system of the present invention in accordance with the disclosed structure. In the present embodiment, a straight top/hanger/mount 402 is designed to be twisted on and twisted off on the base 102. The straight top/hanger/mount 402 has the threads 404 on the inner surface 406 of the circumferential wall 408 to engage with the base 102. The straight top/hanger/mount 402 has an elongated straight hook 410 for hanging a plurality of objects. The elongated hook 410 can include a plurality of protrusions 412 for providing support to the hanging objects.

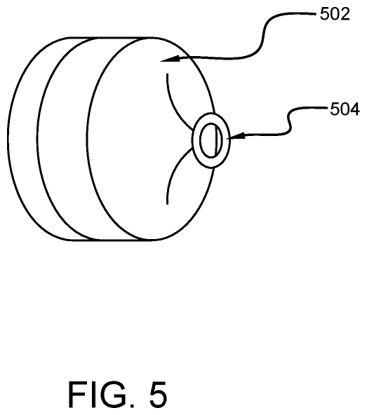

FIG. 5 illustrates yet another embodiment of the multipurpose wall hanging system of the present invention with a circle hook in accordance with the disclosed structure. In the present embodiment, the interchangeable head 502 has a circular hook or loop 504 and can be twisted on and twisted off like other embodiments of the present invention.

It will be apparent to a person skilled in the art that any type of hook disposed on the interchangeable head or top/hanger/mount can be used by a user without removing or replacing the screw. Further, the head or top/hanger/mount is easy to twist on and off and can be interchanged depending on the objects to be hung.

In some embodiments, the circumferential wall of the base and the circumferential wall of the head have opposite magnetic polarities allowing the base and the head to easily attach or fasten together. The magnetic polarities may eliminate the requirement of twisting the head, thereby making it easier for elderly individuals and individuals with limited physical dexterity to use the multifunctional wall hanging system.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “modular wall-mounting wall hanging system”, “multifunctional wall hanging system”, “multifunctional wall-mounted wall hanging system”, “wall hanging system”, and “system” are interchangeable and refer to the modular wall-mounting multifunctional wall hanging system 100 of the present invention.

Notwithstanding the forgoing, the modular wall-mounting multifunctional wall hanging system 100 of the present invention can be of any suitable size and configuration as is known in the art without affecting the overall concept of the invention, provided that it accomplishes the above stated objectives. One of ordinary skill in the art will appreciate that the modular wall-mounting multifunctional wall hanging system 100 as shown in the FIGS. is for illustrative purposes only, and that many other sizes and shapes of the modular wall-mounting multifunctional wall hanging system 100 are well within the scope of the present disclosure. Although the dimensions of the modular wall-mounting multifunctional wall hanging system 100 are important design parameters for user convenience, the modular wall-mounting multifunctional wall hanging system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wall-mounted hanging system comprising;
a circular base having a bottom surface and a base circumferential protruding sleeve;
a mounting fastener; and
a first interchangeable mounting hanger having a first hanger circumferential protruding sleeve;
wherein said mounting fastener extends through said circular base for mounting to a wall;
wherein said base circumferential protruding sleeve having a base plurality of threads;
wherein said first hanger circumferential protruding sleeve having a first hanger plurality of threads; and
further wherein said first hanger plurality of threads selectively threadable on to said base plurality of threads for securing said first interchangeable mounting hanger to said circular base.

2. The wall-mounted hanging system of claim 1, wherein said fastener having at least a first stud screw extending through a center of said bottom surface.

3. The wall-mounted hanging system of claim 2, wherein said first stud screw is a masonry stud screw.

4. The wall-mounted hanging system of claim 2, wherein said fastener having a head for turning said fastener in to said wall.

5. The wall-mounted hanging system of claim 4, wherein said fastener having a washer mounted between said head and said circular base.

6. The wall-mounted hanging system of claim 1, wherein said fastener having a first stud screw and a second stud screw extending through said bottom surface.

7. The wall-mounted hanging system of claim 6, wherein said first stud screw and said second stud screw are self-tapping drywall screws.

8. The wall-mounted hanging system of claim 7 further comprising a second interchangeable mounting hanger having a second hanger circumferential protruding sleeve and a second hanger plurality of threads, wherein said first hanger plurality of threads selectively unthreadable from said base plurality of threads for removing said first interchangeable mounting hanger from said circular base, and further wherein said second hanger plurality of threads selectively threadable on to said base plurality of threads for securing said second interchangeable mounting hanger to said circular base.

9. The wall-mounted hanging system of claim 8, wherein said first interchangeable mounting hanger is different than said second interchangeable mounting hanger.

10. The wall-mounted hanging system of claim 9, wherein said first interchangeable mounting hanger having a protruding circumferential wall including a hook extending therefrom.

11. The wall-mounted hanging system of claim 10, wherein said first interchangeable mounting hanger having a protruding circumferential wall including a loop extending therefrom.

12. The wall-mounted hanging system of claim 10, wherein said second interchangeable mounting hanger having a protruding circumferential wall including a loop extending therefrom.

13. The wall-mounted hanging system of claim 10, wherein said second interchangeable mounting hanger having a protruding circumferential wall including a straight hook with a plurality of raised protrusions extending therefrom.

14. A wall-mounted hanging system comprising;
a circular base having a bottom surface and a base circumferential protruding sleeve;
a mounting fastener;
a first interchangeable mounting hanger having a first hanger circumferential protruding sleeve and a first hanger plurality of threads; and
a second interchangeable mounting hanger having a second hanger circumferential protruding sleeve and a second hanger plurality of threads;
wherein said mounting fastener extends through said circular base for mounting to a wall;
wherein said base circumferential protruding sleeve having a base plurality of threads;
wherein said first hanger plurality of threads selectively threadable on to said base plurality of threads for securing said first interchangeable mounting hanger to said circular base;
wherein said first hanger plurality of threads selectively unthreadable from said base plurality of threads for removing said first interchangeable mounting hanger from said circular base; and
further wherein said second hanger plurality of threads selectively threadable on to said base plurality of threads for securing said second interchangeable mounting hanger to said circular base.

15. The wall-mounted hanging system of claim 14, wherein said first interchangeable mounting hanger is different than said second interchangeable mounting hanger.

16. The wall-mounted hanging system of claim 14, wherein said first interchangeable mounting hanger having a protruding circumferential wall including a hook extending therefrom.

17. The wall-mounted hanging system of claim 16, wherein said second interchangeable mounting hanger having a protruding circumferential wall including a loop extending therefrom.

18. A method of interchanging a wall-mounted hanging system, the method comprising the steps of:
providing a circular base having a bottom surface and a base circumferential protruding sleeve, a mounting fastener, a first interchangeable mounting hanger having a first hanger circumferential protruding sleeve and a first hanger plurality of threads, and a second interchangeable mounting hanger having a second hanger circumferential protruding sleeve and a second hanger plurality of threads, wherein said base circumferential protruding sleeve having a base plurality of threads;
extending said mounting fastener through said circular base for mounting to a wall;
selectively threading said first hanger plurality of threads on to said base plurality of threads;
securing said first interchangeable mounting hanger to said circular base;
selectively unthreading said first hanger plurality of threads from said base plurality of threads;
removing said first interchangeable mounting hanger from said circular base;
selectively threading said second hanger plurality of threads on to said base plurality of threads; and
securing said second interchangeable mounting hanger to said circular base.

19. The method of interchanging a wall-mounted hanging system of claim 18, wherein said first interchangeable mounting hanger is different than said second interchangeable mounting hanger.

20. The method of interchanging a wall-mounted hanging system of claim 19, wherein said first interchangeable mounting hanger having a protruding circumferential wall including a hook extending therefrom, and further wherein said second interchangeable mounting hanger having a protruding circumferential wall including a loop extending therefrom.
